(19) United States
(12) Patent Application Publication
(10) Pub. No.: US 2016/0262036 A1
(43) Pub. Date: Sep. 8, 2016

(54) Method and Arrangement for Forwarding UE Measurements

(71) Applicant: TELEFONAKTIEBOLAGET L M ERICSSON (PUBL), Stockholm (SE)

(72) Inventors: Nianshan Shi, Järfälla (SE); Waikwok Kwong, Solna (SE)

(21) Appl. No.: 14/443,432

(22) PCT Filed: Apr. 20, 2015
(86) PCT No.: PCT/SE2015/050451

§ 371 Date: May 18, 2015

Related U.S. Application Data
(60) Provisional application No. 61/990,947, filed on May 9, 2014.

(51) Int. Cl. H04W 24/10

(52) U.S. Cl. CPC H04W 24/10

(57) ABSTRACT

Methods and communication network nodes for forwarding UE measurement results.

A method is provided which is performed by a first communication network node of a communication network for obtaining measurement results from a wireless communication device in accordance with a Layer 1 communication protocol. A request is formulated 302 for information related to measurements performed by the wireless communication device, the request is sent 304 to a second communication network node, and the requested 302 information is received 306 forwarded from the second communication network node, in accordance with the Layer 1 communication protocol.

By implementing functionality in communication network nodes of a communication network for requesting and forwarding UE measurement results between each other, where the UE measurements results has been delivered to a second one of the communication network on the Layer 1 communication protocol, the first one of the communication network nodes may be enabled to retrieve the UE measurement results in accordance with the Layer 1 communication protocol even if the Layer 1 communication protocol is terminated in the second one of the communication network nodes. Thereby, the first communication network node may retrieve and take the UE measurement results into account when controlling communication of data in the system, which may give rise to a more efficient utilising of installed communication resources.

### TECHNICAL FIELD

The present disclosure relates to management of communication network measurements. Especially it relates to methods and arrangements for enabling a controller node to adjust communication settings based on UE measurements.

### BACKGROUND

The Work Item “Further EUL (Enhanced Uplink) Enhancements” has been agreed in 3GPP Rel 12. One aspect is to improve the EUL coverage via improved TTI (Transmission Time Interval) switching (switching between 10 ms TTI and 2 ms TTI).

The term “wireless communication device” will be used throughout this description to denote any device which is capable of wireless communications. The term wireless communication device may thus include any device, which may be used by a user for wireless communications. Accordingly, the term wireless communication device may alternatively be referred to as a mobile terminal, a terminal, a user terminal (UT), a user equipment (UE), a wireless terminal, a wireless communication device, a wireless transmit/receive unit (WTRU), a mobile phone, a cell phone, a table computer, a smart phone, etc. Yet further, the term wireless communication device includes MTC (Machine Type Communication) devices, which do not necessarily involve human interaction. MTC devices are sometimes referred to as Machine-to-Machine (M2M) devices.

With reference to FIG. 1, which is a schematic overview, a scenario where an RNC (Radio Network Controller) controls NodeBs, which each serves a plurality of UEs, will now be described in accordance with one example.

The RNC 100 is arranged in a communication network to control the NodeBs 102. For instance, the RNC 100 controls scheduling of communication between the NodeBs 102 and their respective UEs 104. Today, the UEs perform UE measurements of various communication parameters.

UE measurements results are utilized in different ways. Most UE measurement results are forwarded transparently from the NodeB to the RNC. However, some UE measurement results, e.g. UE Power Headroom (UPH), Total E-DCH Buffer Status (TEBS), and Filtered UE Power Headroom, are delivered to the NodeB on a Layer 1 (L1) communication protocol. UPH and TEBS are carried in a Scheduling Information (SI) and the Filtered UPH is carried in a MAC Control Information (MCI). Both the SI and the MCI are 18-bit messages that are delivered to the NodeB on a Layer 1 communication protocol, which is terminated in the NodeBs.

However, it is desirable to improve effectiveness and flexibility in communication networks in order to make better use of installed communication resources. For instance, there is a need for devising a solution which may enable communication network nodes to improve effectiveness for acquiring measurement data of wireless communication devices.

### SUMMARY

It would be desirable to obtain improved performance for services in communication networks. It is an object of this disclosure to address at least any of the issues outlined above.

Further, it is an object to provide a communication network node with functionality of forwarding UE measurement results to another communication network node in accordance with a Layer 1 communication protocol. These objects may be met by methods and arrangements according to the attached independent claims.

According to one aspect, a method is provided which is performed by a first communication network node of a communication network for obtaining measurement results from a wireless communication device in accordance with a Layer 1 communication protocol. The method comprises: formulating a request for information related to measurements performed by the wireless communication device; sending the request to a second communication network node; and receiving, from the second communication network node, the requested information in accordance with the Layer 1 communication protocol.

Furthermore, formulating the request may comprise defining that the information will comprise as at least one of: a measurement Identity, a measurement type, a measurement value, the complete measurement result, and an indication that the wireless communication device has triggered the measurement. Sending the request may comprise sending a UPH (User Equipment power Headroom) Filtering Measurement Forwarding Request IE (Information Element), included in at least one of: a radio link setup request message, a radio link addition request message, a radio link reconfiguration prepare message, and a radio link reconfiguration request message. Moreover, receiving the requested information may comprise receiving the requested information formulated as UPH Filtering Value IE of a UE (User Equipment) Measurement Forwarding IE included in a radio link parameter update indication message.

According to second aspect, a method is provided which is performed by second communication network node of a communication network for forwarding measurement results from a wireless communication device to a first communication network node in accordance with a Layer 1 communication protocol. The method comprises: receiving, from the first communication network node, a request for information related to measurements performed by the wireless communication device; receiving from the wireless communication device, measurement results of the performed measurements delivered on the Layer 1 communication protocol; and forwarding, to the first communication network node, the information according to the received request in accordance with the received request.

Furthermore, receiving the request for information may comprise receiving a definition that the information will comprise as at least one of: a measurement Identity, a measurement type, a measurement value, the complete measurement results, and an indication that the wireless communication device has triggered the measurement.

Moreover, forwarding the information according to the received request may comprise forwarding the requested information formulated as UPH Filtering Value IE of a UE Measurement Forwarding IE included in a radio link parameter update indication message.

According to further aspects, a first and a second communication network node are provided, which are adapted to perform the method steps of the above described respective methods. The first communication network node may be implemented as a Radio Network Controller, and the second communication network node may be implemented as a NodeB. Both the first and second communication network nodes comprise a communication module and a controller, respectively.

According to yet another aspect, a system which comprises the first and second communication network nodes is also provided.

By implementing functionality in communication network nodes of a communication network for requesting and forwarding UE measurement results between each other, where the UE measurements results has been delivered to a second one of the communication network on the Layer 1 communication protocol, the first one of the communication network nodes may be enabled to retrieve the UE measurement results in accordance with the Layer 1 communication protocol even if the Layer 1 communication protocol is terminated in the second one of the communication network nodes. Thereby, the first communication network node may retrieve and take the UE measurement results into account when controlling communication of data in the system, which may give rise to a more efficient utilising of installed communication resources.

### BRIEF DESCRIPTION OF DRAWINGS

The solution will now be described in more detail by means of exemplary embodiments and with reference to the accompanying drawings, in which:

FIG. 1 is a schematic illustration of a situation in accordance with the existing art.

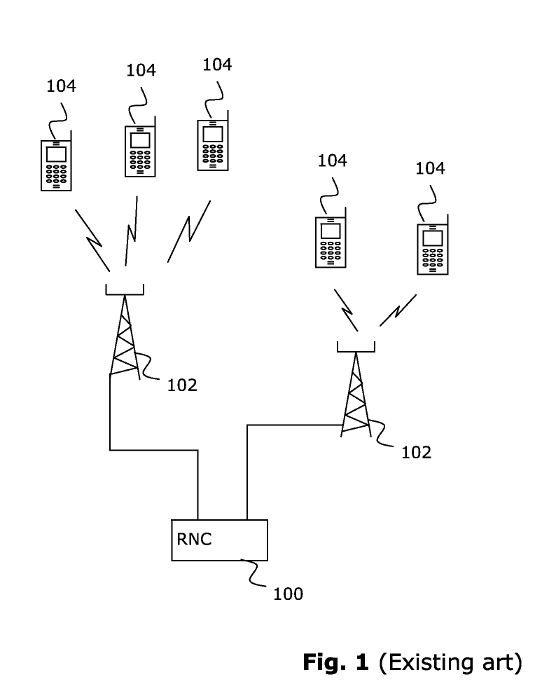

FIG. 2 is a schematic signalling chart, according to possible embodiments.

FIG. 3 is a schematic flow chart of methods, according to possible embodiments.

FIG. 4 is a schematic flow chart of methods, according to possible embodiments.

FIG. 5 is a schematic block diagram of a communication network node, according to possible embodiments.

FIG. 6 is a schematic block diagram of a communication network node, according to possible embodiments.

FIG. 7 is a schematic block diagram of a computer program product, according to possible embodiments.

### DETAILED DESCRIPTION

The triggering and the content of the report referred to above are also of interest to the RNC, but there is currently no mechanism for the NodeB to forward a UE measurement report to the RNC.

The solution is to provide a way to let a NodeB forward the UE measurement results, e.g. parts of a UE measurement report, to the RNC in accordance with the Layer 1 communication protocol. The accompanying exemplifying embodiments of this document disclose some implementations where a NodeB forwards requested parts of UE measurement results to an RNC. As will be disclosed, the NodeB extracts, e.g. by filtering requested parts of the UE measurement results which are delivered from a UE to the NodeB on a Layer 1 communication protocol before forwarding the extracted parts to the RNC. Because the requested parts are extracted from UE measurement results which were delivered on a Layer 1 communication protocol before being forwarded to the RNC, the forwarded parts are forwarded in accordance with the Layer 1 communication protocol.

Throughout this description the term “Layer 1” or the abbreviation “L1” will be used to denote any appropriate communication protocol for communication of UE measurement results, e.g. MAC (Medium Access Control, SI (Scheduling Information), etc.

To assist the TTI switching, a new UE (User Equipment) measurement based on the existing UPH (UE transmission power headroom) measurement primitive is used. This new measurement augments the UPH primitive with Layer 3 filtering and reporting criteria. It is configured in the UE via RRC (Radio Resource Control) Measurement Control by RNCs (Radio Network Controllers).

The delivery of the report, however, is not done using the normal RRC Measurement Report message. Instead, the report is a MAC (Medium Access Control)-layer message that terminates in the NodeB and is used mainly by the NodeB itself. To distinguish it from the UPH primitive that is reported as one of the fields in the Scheduling Information (SI) MAC message, it is referred to here as a UPH Report.

Via NBAP (NodeB Application Part), RNC can request the NodeB to do measurements on common resources; RNC can also request the NodeB to do measurement on dedicated resources in the NodeB. The specification defines how RNC initiates the NodeB measurement, how the NodeB reports the measurement being initiated by the RNC, how RNC terminates the measurement and how NodeB reports the failure when the process goes wrong.

Similarly, RNC can control UE measurement either by broadcast of SYSTEM INFORMATION and/or by transmitting a MEASUREMENT CONTROL via RRC. The UE uses the measurement reporting procedure over RRC to transfer measurement results to UTRAN (Universal Terrestrial Radio Access Network).

Currently there is no way to forward the UE measurement from NodeB to RNC.

In this description, we describe solutions for the NodeB to forward UE measurements that are received and terminated in the NodeB to the RNC: when the RNC instruct the UE via RRC to perform the dedicated measurement that is to be reported in Layer 1, the RNC will also instruct the NodeB to perform the UE measurement result forwarding, if RNC wishes to receive the measurement result. The NodeB shall, at the time it receives the UE measurement, forward the result to RNC accordingly.

UE measurements reported in Layer 1 are often designed for NodeB use. However the RNC could also use it in decision making when it receives the UE measurement forwarded by the NodeB.

Throughout this description, the term “Layer 1 communication protocol” will be utilised to denote a communication protocol which terminates in a NodeB and is applied for communication of data between UE:s and NodeBs. For instance, such communication protocol could be implemented as MAC (Media Access Control) Control Information or SI (Scheduling Information), without being limited thereto. As will be further disclosed in the following exemplifying embodiments, the NodeB receives measurement results from the UE on the Layer 1 communication protocol. The NodeB extracts parts of these received measurement results according to the requests and forward the extracted parts to the RNC as specific IEs (Information Elements) in Radio Link Parameter Update Indication messages. Thus, even if the actual Layer 1 communication protocol is terminated in the NodeB, by extracting the parts of the measurement results which have been delivered on the Layer 1 communication protocol, the NodeBs will thereby be enabled to forward measurement results in accordance with the Layer 1 communication protocol.

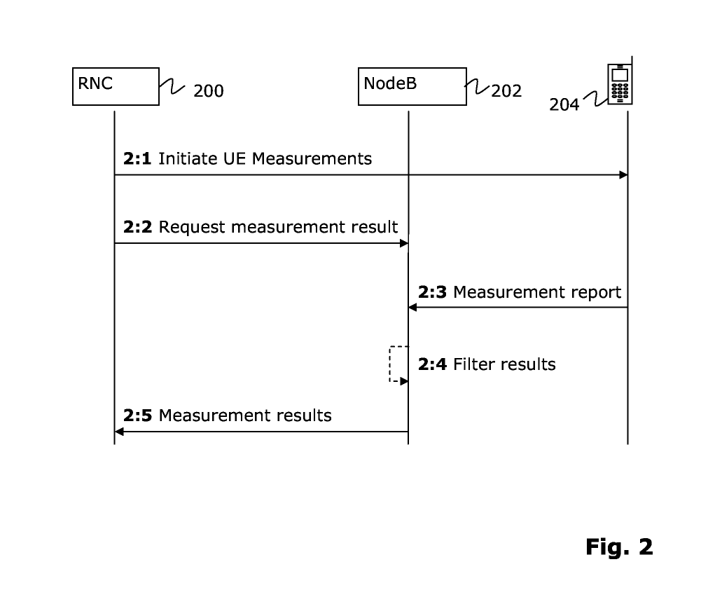

With reference to FIG. 2 which is a schematic flow chart, a scenario among the RNC 200, the NodeB 202 and the UE 204, will now be described in accordance with one exemplifying embodiment.

When configuring the UE 204 with a measurement that terminates in the NodeB 202, the RNC 200 also instructs the NodeB 202 whether it should inform the RNC 200 of the reception of such measurements. This can be done by introducing an indication from RNC 200 to NodeB 204. For example, if RNC 200 wishes to receive the UPH filtering UE measurement, a “UPH Filtering UE measurement reporting request” indicator can be introduced in the existing NBAP/RNSAP (NodeB Application Part/Radio Network Subsystem Application Part) messages. In the figure, some action steps are illustrated, which will be listed.

In Step 1 (2:1 in the figure): RNC initiate a dedicated UE measurement.
In Step 2 (2:2 in the figure): The RNC request NodeB to perform the measurement forwarding.
In Step 3 (2:3 in the figure): The measurement result is read on L1 by the NodeB.
Step 4 (2:5 in the figure): The measurement result is forwarded to RNC.
In another exemplifying embodiment, which is based on the above described one, in addition, the NodeB 202 extracts the requested measurement results in an additional action 2:4. In this embodiment this is performed by filtering out the requested measurement results according to the request. In other words the action the Step 4 of forwarding the measurement results may comprise both the action 2:4 of extracting a part of the measurement results in accordance with the Layer 1 communication protocol, and the action of sending the extracted part of the measurement results in accordance with the Layer 1 communication protocol.

Table 1 below shows an example that an indicator can be added to an existing IE (Information Element) so that the NodeB is instructed to do the UE measurement forwarding. In this example, the existing IE E-DCH FDD Information is used in dedicated Radio Link Setup/Addition/Reconfiguration messages, which means that the RNC could instruct the NodeB when a dedicated Radio Link is Setup/Added/reconfigured.

However, the disclosed concept is not limited to the above described scenario, and a designer may provide some of the nodes with additional of alternative functionality. In an alternative embodiment which is related to the one described above, the RNC is adapted to configure how the NodeB should forward the UE measurement report. In a further alternative embodiment the RNC's action of requesting the NodeB to do the measurement result forwarding may be skipped. In this alternative embodiment, the NodeB will forward measurement results also when the RNC 200 does not indicate its interest, i.e. when the RNC does not send any request.

Furthermore, when the NodeB 202 has received and decoded such a measurement, the information can be forwarded to the RNC 200 in different ways. Three possible solutions therefore will now be described according to some exemplifying embodiments

Solution 1: The NodeB 202 extracts detailed information such as measurement Identity and the measurement result and forwards them to the RNC 200 as NBAP IEs such as “Measurement Identity”, “Measurement Type”, and “Measurement Value”. The RNC can then recover the full result of the measurement. RNC 200 then can decide on the next step according to its network strategy.

To forward the UE measurement we can either extend one or more of the existing messages in NBAP/RNSAP or over Iu/Iur user plane, or introduce a new message. Table 2 is an example to extend the RADIO LINK PARAMETER UPDATE INDICATION.

Solution 2: The NodeB 202 forwards the whole message to the RNC 200. This solution is easier at the NodeB side, but it requires extra effort from the RNC in decoding the message since most UE-to-NodeB messages are not coded in ASN.1.

To forward the whole UE measurement content we can either extend an existing message, or introduce a new message.

Solution 3: Instead of forwarding the measurement result, the NodeB 202 only sends an indication to RNC 100 to flag that such a measurement report has being triggered by the UE 204. The RNC 200 will understand that UE 204 has triggered the reporting of the measurement. Based on this indication, the RNC 200 can conclude that the measurement has become worse or better than certain thresholds. The RNC 200 can then make an informed decision.

An indication can be introduced in one or more of the existing messages.

Table 3 is an example for adding an indicator in the RADIO LINK PARAMETER UPDATE INDICATION.

By introducing functionality in the RNCs and NodeBs to forward UE measurements terminated in the NodeB to the RNCs, the RNCs may be able to appropriately adjust communication network deployment strategy based on the at least one part of measurement results, and thereby a more effective and use of installed communication resources may be achieved.

The UE measurement results reported via Layer 1 (e.g. MAC, SI or other appropriate method) can be forward from NodeB to RNC.

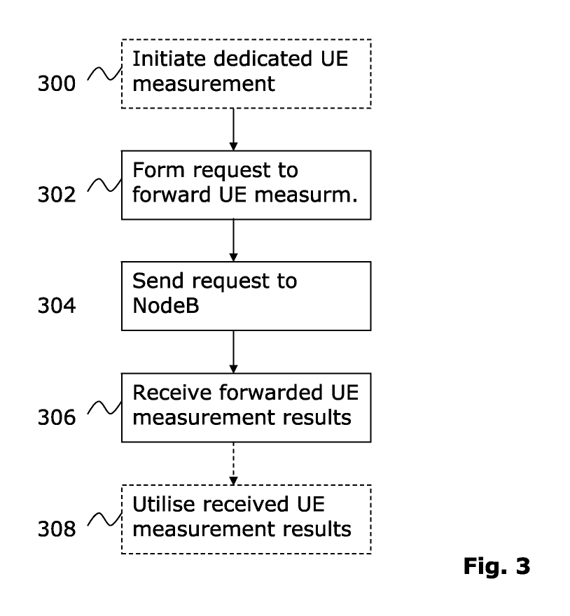

With reference to FIG. 3, which is a schematic flow chart, a method performed by an RNC (Radio Network Controller) for obtaining measurement results from a wireless communication device will now be described in accordance with one exemplifying embodiment.

The RNC is a first communication network node which is arranged in a communication network to control a plurality of NodeBs. The NodeBs are second communication network nodes which each serve a plurality wireless communication devices.

In an action 302, the RNC formulates a request for UE measurement results from the NodeB. The request comprises a definition of what information that is requested and the request is implemented as a UPH (UE Power Headroom) Filtering UE (User Equipment) measurement reporting request and is included in a radio link setup message when being sent to the NodeB in a following action 304. Alternatively, the UPH Filtering UE measurement reporting request may instead be included in any of: a radio link addition request message, a radio link reconfiguration prepare message, a radio link reconfiguration request message, or any suitable combination thereof. The sequence of the actions 302 and 304 corresponds to the step 2:2 of described above with conjunction to the FIG. 2.

When the NodeB receives UE measurement results from the UE on a Layer 1 communication protocol, the NodeB extracts the requested information according to the request, i.e. according to the received definition, and forwards the extracted information.

In a following action 306, the forwarded information is received from the NodeB. The action 306 correspond to the step 2:5 described above with conjunction to the FIG. 2. In this embodiment, the Information Elements “UE Measurement Forwarding”, and “UE Measurement Value” are utilised for forwarding the information.

In addition, in the action 306 the received information may by confirmed by sending an information element “UE Measurement received” in response from the RNC to the NodeB. This additional information element is defined below in Table 3.

Then the RNC will be enabled to utilise the received information, i.e. The UE measurement results in a following action 308.

In a related exemplifying embodiment which is based on the above described embodiment, the action 302 of formulating the request may be preceded with an initial action 300, in which the RNC initiates the UE measurements. Thus, the disclosed concept of obtaining the UE measurement results may be applied both when the RNC actively requests measurements to be performed and when the RNC instead monitors UE measurements which are performed.

In addition, the RNC may obtain the UE measurement results: by either requesting specific measurement parameters to be extracted by the NodeB from a plurality of received measurement parameters; by requesting the NodeB to forward all received measurement results and extracting the measurement parameters itself; or by requesting the NodeB to monitor measurement results and forwarding a measurement parameter when it exceeds a threshold.

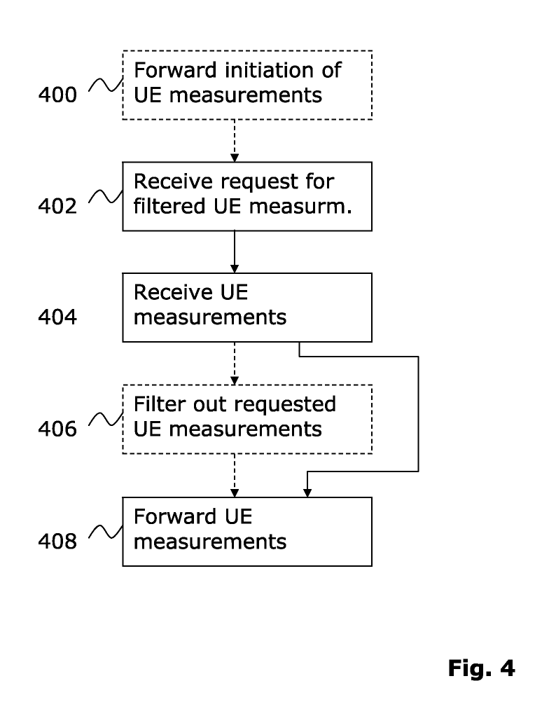

With reference to FIG. 4, which is a schematic flow chart, a method performed by a NodeB which is arranged in a communication network will now be described in accordance with one exemplifying embodiment.

The NodeB is arranged in a communication network and is communicatively connected to an RNC and a plurality of wireless communication devices, e.g. UEs.

In one action 402, the NodeB receives a request for UE measurement results from the RNC. The request has been described in other embodiments of this description and will therefore not be further discussed in this embodiment. In a following action 404, which corresponds to the step 2:3 of FIG. 2, the requested UE measurement results are received on a Layer 1 communication protocol.

In an optional action 406, the requested UE measurement results may be extracted from the received UE measurement results, corresponding to the step 2:4 of FIG. 2. As described above the extraction may be performed by filtering the received UE measurement results in accordance with a received definition.

In a final action 408, the UE measurement results, either all the received UE measurement results or the extracted measurement parameter(s) of the received UE measurement results, are forwarded to the RNC. The forwarding corresponds to the reception of action 306 and step 2:5.

In the embodiments above information regarding results from UE measurements, which has been delivered to NodeBs on a Layer 1 communication protocol, are forwarded included in specific information elements in specific messages to RNCs. However, the disclosed concept is not limited to these specific information elements messages, and the NodeB may instead include the requested measurement results in any suitable information elements and messages when forwarding the requested information regarding UE measurements in accordance with the Layer 1 communication protocol.

Table 1 below shows an example that an indication can be added (last line in the table,) to the existing IE E-DCH FDD Information which is included in the dedicated Radio Link messages (TS 25.433), so that NodeB is instructed to do the UE measurement forwarding.

9.2.2.13 Da E-DCH FDD Information

The E-DCH FDD Information IE provides information for an E-DCH to be established.

TABLE 1

| | | | IE Type and | Semantics | | Assigned |
|---|---|---|---|---|---|---|
| IE/Group Name | Presence | Range | Reference | Description | Criticality | Criticality |
| E-DCH MAC-d Flows | M | | 9.2.2.13M | | — | |
| Information | | | | | | |
| HARQ Process Allocation For | O | | HARQ Process | If this IE is | — | |
| 2 ms Scheduled Transmission | | | Allocation for | not included, | | |
| Grant | | | 2 ms TTI | scheduled | | |
| | | | 9.2.2.13Dn | transmission | | |
| | | | | in all HARQ | | |
| | | | | processes is | | |
| | | | | allowed. | | |
| E-DCH Maximum Bitrate | O | | 9.2.2.13T | | — | |
| E-DCH Processing Overload | O | | 9.2.1.79 | | — | |
| Level | | | | | | |
| E-DCH Reference Power | O | | 9.2.2.13Y | | — | |
| Offset | | | | | | |
| E-DCH Power Offset for | O | | 9.2.1.85 | | YES | ignore |
| Scheduling Info | | | | | | |
| SixteenQAM UL Operation | O | | 9.2.2.88A | | YES | reject |
| Indicator | | | | | | |
| E-AGCH Table Choice | C- | | 9.2.2.100 | If the | YES | ignore |
| | SixteenQAM | | | SixteenQAM | | |
| | UL | | | UL operation | | |
| | Operation | | | is not | | |
| | | | | configured | | |
| | | | | for this UE, | | |
| | | | | Table 16B for | | |
| | | | | E-AGCH in | | |
| | | | | TS 25.212 [8] | | |
| | | | | shall be | | |
| | | | | used. | | |
| SixtyfourQAM UL Operation | O | | 9.2.2.88C | | YES | reject |
| Indicator | | | | | | |
| UL MIMO Information | O | | 9.2.2.177 | | YES | reject |
| UPH Filtering UE | O | | ENUMERATED | | YES | reject |
| measurement reporting | | | (Requested, Not | | | |
| request | | | Requested) | | | |

Table 2 below shows an example that the existing message (in TS 25.433) can be extended to forward the UE measurements. These extensions, i.e. both the extension line (UE Measurement Forwarding) of table 2 and the actual extension (UE Measurement Value) of 9.2.2.x.x are defined below, where the numbers “9.1.89”, “9.1.89.1”, and “9.2.2.x.x” refer to paragraphs of the 3GPP (Third Generation Partnership Project) Technical Specification.

9.1.89 Radio Link Parameter Update Indication

9.1.89.1 FDD Message

TABLE 2

| | | | IE Type and | Semantic | | Assigned |
|---|---|---|---|---|---|---|
| IE/Group name | Presence | Range | Reference | Description | Criticality | Criticality |
| Message Discriminator | M | | 9.2.1.45 | | — | |
| Message Type | M | | 9.2.1.46 | | YES | ignore |
| Transaction ID | M | | 9.2.1.62 | | — | |
| CRNC Communication | M | | 9.2.1.18 | The reserved | YES | ignore |
| Context ID | | | | value | | |
| | | | | “All CRNCCC” | | |
| | | | | shall not be | | |
| | | | | used. | | |
| HS-DSCH FDD Update | O | | 9.2.2.18Ea | | YES | ignore |
| Information | | | | | | |
| E-DCH FDD Update | O | | 9.2.2.13DA | | YES | ignore |
| Information | | | | | | |
| Additional HS Cell | | 0 . . . <maxNr | | For secondary | EACH | ignore |
| Information RL Param Upd | | OfHSDSCH- | | serving HS- | | |
| | | 1> | | DSCH cell. | | |
| | | | | Max 7 in this | | |
| | | | | 3GPP release. | | |
| >HS-PDSCH RL ID | M | | RL ID | | — | |
| | | | 9.2.1.53 | | | |
| >HS-DSCH FDD | M | | 9.2.2.18Eaa | | — | |
| Secondary Serving Update | | | | | | |
| Information | | | | | | |
| Additional E-DCH Cell | | 0 . . . <maxNr | | E-DCH on | EACH | ignore |
| Information RL Param Upd | | OfEDCH- | | Secondary | | |
| | | 1> | | uplink | | |
| | | | | frequency - | | |
| | | | | max 1 in this | | |
| | | | | 3GPP release. | | |
| >>Additional E-DCH FDD | M | | 9.2.2.138 | | — | |
| Update Information | | | | | | |
| CPC Recovery Report | O | | ENUMERATED | | YES | ignore |
| | | | (Initiated, | | | |
| | | | . . . ) | | | |
| UL CLTD State Update | O | | 9.2.2.155 | | YES | ignore |
| Information | | | | | | |
| UE Measurement Forwarding | O | | 9.2.2.xx | | YES | ignore |

9.2.2.xx UE Measurement Forwarding

| | | | IE Type and | |
|---|---|---|---|---|
| IE/Group Name | Presence | Range | Reference | Semantics Description |
| Measurement ID | M | | 9.2.1.42 | |
| UE Measurement Value | M | | New defined IE | |

Table 3 below shows an example that only an indicator (last line in the table 3) is introduced to the existing message (TS 25.433). The indicator could also be defined very specific, such as “UPH Filtering Measurement Received”.

9.1.89 Radio Link Parameter Update Indication

9.1.89.1 FDD Message

TABLE 3

| | | | IE Type and | Semantic | | Assigned |
|---|---|---|---|---|---|---|
| IE/Group name | Presence | Range | Reference | Description | Criticality | Criticality |
| Message Discriminator | M | | 9.2.1.45 | | — | |
| Message Type | M | | 9.2.1.46 | | YES | ignore |
| Transaction ID | M | | 9.2.1.62 | | — | |
| CRNC Communication | M | | 9.2.1.18 | The reserved | YES | ignore |
| Context ID | | | | value | | |
| | | | | “All CRNCCC” | | |
| | | | | shall not be | | |
| | | | | used. | | |
| HS-DSCH FDD Update | O | | 9.2.2.18Ea | | YES | ignore |
| Information | | | | | | |
| E-DCH FDD Update | O | | 9.2.2.13DA | | YES | ignore |
| Information | | | | | | |
| Additional HS Cell | | 0 . . . <maxNr | | For secondary | EACH | ignore |
| Information RL Param Upd | | OfHSDSCH- | | serving HS- | | |
| | | 1> | | DSCH cell. | | |
| | | | | Max 7 in this | | |
| | | | | 3GPP release. | | |
| >HS-PDSCH RL ID | M | | RL ID | | — | |
| | | | 9.2.1.53 | | | |
| >HS-DSCH FDD | M | | 9.2.2.18Eaa | | — | |
| Secondary Serving Update | | | | | | |
| Information | | | | | | |
| Additional E-DCH Cell | | 0 . . . <maxNr | | E-DCH on | EACH | ignore |
| Information RL Param Upd | | OfEDCH- | | Secondary | | |
| | | 1> | | uplink | | |
| | | | | frequency - | | |
| | | | | max 1 in this | | |
| | | | | 3GPP release. | | |
| >>Additional E-DCH FDD | M | | 9.2.2.138 | | — | |
| Update Information | | | | | | |
| CPC Recovery Report | O | | ENUMERATED | | YES | ignore |
| | | | (Initiated, | | | |
| | | | . . . ) | | | |
| UL CLTD State Update | O | | 9.2.2.155 | | YES | ignore |
| Information | | | | | | |
| UE Measurement received | O | | ENUMERATED | | YES | ignore |
| | | | (UPH | | | |
| | | | Filtering | | | |
| | | | Measurement | | | |
| | | | Received, | | | |
| | | | . . . ) | | | |

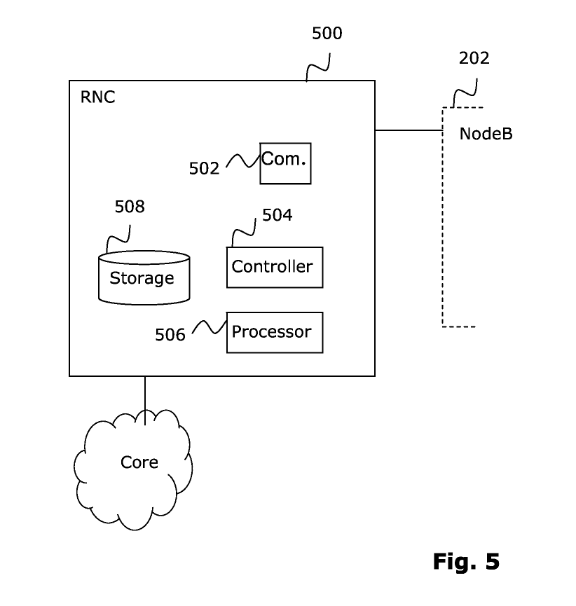

With reference to FIG. 5, which is a schematic block diagram, an RNC 500 will now be described in accordance with one exemplifying embodiment.

The RNC 500 is a first communication network node, which is connected to a NodeB 202, i.e. a second communication network node. The RNC 500 is further connected to a core network to serve UEs and other wireless communication devices (not shown).

The RNC 500 comprises a communication module 502, a controller 504, and optionally a processor 506 and a storage module 508.

The controller 504 is adapted to request the NodeB 202 to forward at least one part of measurement results which the NodeB has received from the UEs to the RNC 500, wherein the forwarding will be performed in accordance with a layer 1 communication protocol. The communication module 502 is adapted to receive the forwarded measurements result from the NodeB 202.

In an alternative exemplifying embodiment which is based on the one described above, the controller 504 is further adapted to adjust a communication network deployment strategy based on the at least one part of measurement results. For instance scheduling settings, etc. may be adjusted.

Moreover, the controller 504 may be further adapted to request different amounts of measurement results from the NodeB 202. For instance, the controller 504 may request the NodeB 202 to forward specific measurement results, forward all received measurement results, or just notify the RNC 500 when the NodeB 202 receives measurement results. In the case when all measurement results will be forwarded, the actual request action may be performed by pre-defining that the NodeB 202 will forward all received measurement results.

Furthermore, the optional storage module 508 and processor 506 may be arranged to provide additional storage capacity and calculating capacity to the RNC.

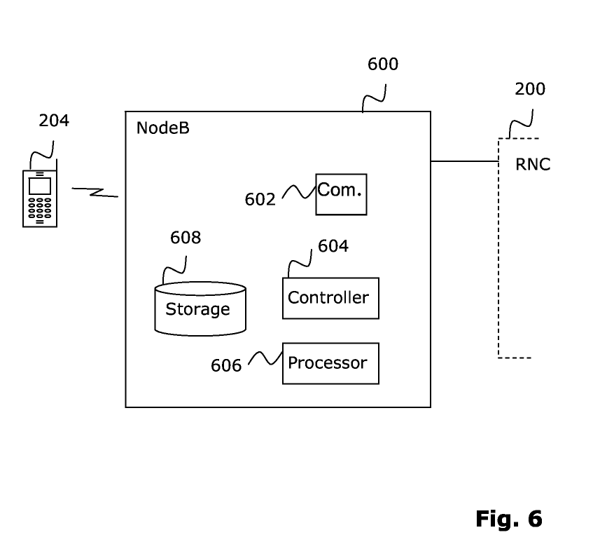

With reference to FIG. 6, which is a schematic block diagram, a NodeB 600 will now be described in accordance with one exemplifying embodiment.

The NodeB 600 is a second communication network node, which is connected to an RNC 200, i.e. a first communication network node. The NodeB 600 is further connected to a serve a UE 204 and other wireless communication devices (not shown).

The NodeB 600 comprises a communication module 602, a controller 604, and optionally a processor 606 and a storage module 608.

The communication module 602 is adapted to receive a request from the RNC 200 to forward at least one part of the measurement results received from the UEs 204.

The controller 604 is adapted to adapted to put together the requested at least one part of the measurement results according to the received request. The communication module 602 is further adapted to forward the at least one part of the measurement results being put together.

As already discussed above in conjunction with another exemplifying embodiment, the NodeB 600 may be requested to forward different amounts of measurement results.

Furthermore, the optional storage module 608 and processor 606 may be arranged to provide additional storage capacity and calculating capacity to the NodeB, e.g. for extracting appropriate parameters of received measurement results before forwarding the parts of or all received measurement results to the RNC 200.

Regarding the RNC 500 and the NodeB 600 of the above exemplifying described embodiments, it is to be noted that they are described in a non-limiting manner. Typically, a designer may select to arrange further units and components in to provide appropriate operation, within the described concept, e.g. a further processors communication modules and storage means may be arranged. Moreover, physical implementations of the proposed arrangements may be performed alternatively within the disclosed concept. For instance, functionality of a specific illustrated unit may be implemented in another suitable unit when put into practice.

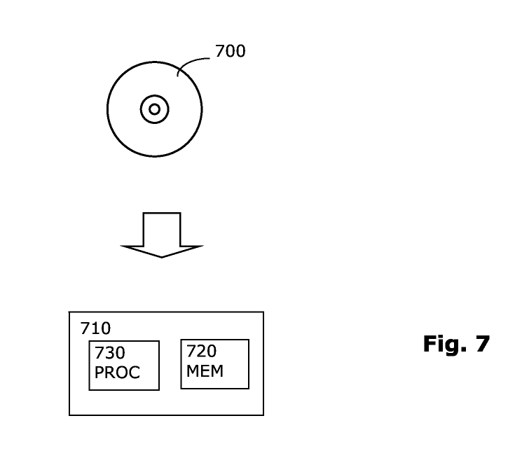

According to some exemplifying embodiments, a computer program product comprises a computer readable medium such as, for example, a diskette or a CD-ROM as illustrated by 700 in FIG. 7. The computer readable medium may have stored thereon a computer program comprising program instructions. The computer program may be loadable into a data-processing unit 730, which may, for example, be comprised in a communication network node 710. When loaded into the data-processing unit 730, the computer program may be stored in a memory 720 associated with or integral to the data-processing unit 730. According to some embodiments, the computer program may, when loaded into and run by the data-processing unit 730, cause the data-processing unit 730 to execute method steps according to, for example, the methods shown in the FIGS. 2, 3, and 4, respectively.

It is to be noted that the arrangements of the described exemplifying embodiments are described in a non-limiting manner. Typically, a designer may select to arrange further units and components to provide appropriate operation of the communication network node, within the described concept, e.g. further processors or memories. Moreover, physical implementations of the proposed arrangements may be performed alternatively within the disclosed concept. For instance, functionality of a specific illustrated unit or module may be implemented in another suitable unit or module when put into practice.

Reference throughout the specification to “one embodiment” or “an embodiment” is used to mean that a particular feature, structure or characteristic described in connection with an embodiment is included in at least one embodiment. Thus, the appearance of the expressions “in one embodiment” or “in an embodiment” in various places throughout the specification are not necessarily referring to the same embodiment. Further, the particular features, structures or characteristics may be combined in any suitable manner in one or several embodiments. Although the present invention has been described above with reference to specific embodiments, it is not intended to be limited to the specific form set forth herein. Rather, the invention is limited only by the accompanying claims and other embodiments than the specific above are equally possible within the scope of the appended claims. Moreover, it should be appreciated that the terms “comprise/comprises” or “include/includes”, as used herein, do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

### ABBREVIATIONS

Within this description some of the abbreviations below have been used.
DRNC Drifting Radio Network Controller
E-DCH Enhanced dedicated channel
HS-DSCH High-Speed DSCH
HS-SCCH High speed shared control channel
HSDPA High Speed Downlink Packet Access
IE Information Element
L1 Layer 1
MAC Medium Access Control
MCI MAC Control Information
NBAP NodeB Application Part
RNC Radio Network Controller
RNSAP Radio Network Subsystem Application Part
SI Scheduling Information
SRNC Serving Radio Network Controller
TEBS Total E-DCH Buffer Status
UE User Equipment
UL Uplink
UPH UE Power Headroom

### Numbered Exemplifying Embodiments, NEEs

### NEE1

A system for enabling a first communication network node (200) to obtain measurement results from a wireless communication device (204) on a layer 1 communication protocol, the system comprising:
the first communication network node (200) adapted to request a second communication network node (202) to forward at least one part of the measurement results received from the wireless communication device (204) to the first communication network node (200), and
the second communication network node (202) adapted to receive the measurement results from the wireless communication device (204) and to forward the at least one part of the measurement results to the first communication network node (200) in accordance with the Layer 1 communication protocol.

### NEE2

The system according to NEE1, wherein the first communication network node (200) is further adapted to adjust a communication network deployment strategy based on the at least one part of measurement results.

### NEE3

The system according to NEE1 or NEE2, further comprising the wireless communication device (204), wherein:
the first communicant network node (200) is further adapted to initiate the wireless communication device (204) to perform the measurements, and
the wireless communication device (204) is adapted to perform the measurements and send the measurement results to the second communication network node (202).

### NEE4

A first communication network node (500) adapted to obtain measurement results from a wireless communication device (204) on a layer 1 communication protocol, the first communication network node comprising:
a controller (504) adapted to request a second communication network node (202) to forward at least one part of measurement results received from the wireless communication device (504) to the first communication network node (500), and
a communication module (502) adapted to receive the forwarded at least one part of measurement.

### NEE5

The first communication network node (500) according to NEE4, wherein the controller (504) is further adapted to adjust a communication network deployment strategy based on the at least one part of measurement results.

### NEE6

The first communication network node (500) according to NEE4 or NEE5, wherein the controller (504) is further adapted to request the second communication network node (202) to forward any of: the complete received measurement results, specific parts of the received measurement results, and an indication that the measurement results has been received.

### NEE7

A second communication network node (600) adapted to forward measurement results received from a wireless communication device (204) to a first communication network node (200) on a layer 1 communication protocol, the second communication network node comprising:
a communication module (602) adapted to receive a request from the first communication network node (200), and
a controller (604) adapted to put together the requested at least one part of the measurement results according to the received request,
wherein the communication module (602) is further adapted to forward the at least one part of the measurement results being put together.

### NEE8

The second communication network node (600) according to NEE7, wherein the controller (604) is further adapted to decide which parts of the measurement results which will be forwarded.

1-29. (canceled)

30. A method performed by a first communication network node of a communication network for obtaining measurement results from a wireless communication device in accordance with a Layer 1 communication protocol, the method comprising:
formulating a request for information related to measurements performed by the wireless communication device;
sending the request to a second communication network node; and
receiving, from the second communication network node, the requested information in accordance with the Layer 1 communication protocol.

31. The method according to claim 30, wherein formulating the request comprises defining that the information will comprise as at least one of: a measurement identity, a measurement type, a measurement value, the complete measurement result, and an indication that the wireless communication device has triggered the measurement.

32. The method according to claim 30, wherein sending the request comprises sending a User Equipment power Headroom (UPH) Filtering Measurement Forwarding Request Information Element (IE) included in at least one of: a radio link setup request message, a radio link addition request message, a radio link reconfiguration prepare message, and a radio link reconfiguration request message.

33. The method according to claim 30, wherein receiving the requested information comprises receiving the requested information formulated as UPH Filtering Value IE of a UE Measurement Forwarding IE included in a radio link parameter update indication message.

34. The method according to claim 30, further comprising adjusting a communication network deployment strategy of the communication network based on the received information.

35. A first communication network node adapted to be arranged in a communication network for obtaining measurement results from a wireless communication device in accordance with a Layer 1 communication protocol, the first communication network node comprising:
a communication circuit; and
a controller;
wherein the controller is configured to formulate a request for information related to measurements performed by the wireless communication device, and the communication circuit is configured to forward the formed request to a second communication network node and receive, from the second communication network node, the requested information in accordance with the Layer 1 communication protocol.

36. The first communication network node according to claim 35, wherein the controller is configured to formulate the request as defining that the information will comprise as at least one of: a measurement identity, a measurement type, a measurement value, the complete measurement result, and an indication that the wireless communication device has triggered the measurement.

37. The first communication network node according to claim 35, wherein the communication module is configured to send the request formed as a User Equipment Power Headroom (UPH) Filtering Measurement Forwarding Request Information Element (IE) included in at least one of: a radio link setup request message, a radio link addition request message, a radio link reconfiguration prepare message, and a radio link reconfiguration request message.

38. The first communication network node according to claim 35, wherein the communication circuit is configured to receive the requested information formulated as an UPH Filtering Value IE of a UE Measurement Forwarding IE included in a radio link parameter update indication message.

39. The first communication network node according to claim 35, wherein the controller is further configured to adjust a communication network deployment strategy of the communication network based on the received information.

40. The first communication network node according to claim 35, wherein the communication circuit is configured to receive the information forwarded from the second communication network node formulated as a UPH filtering value delivered in accordance with the Layer 1 communication protocol.

41. The first communication network node according to claim 35, wherein the first communication network node is a Radio Network Controller (RNC).

42. A method performed by a second communication network node of a communication network for forwarding measurement results from a wireless communication device to a first communication network node in accordance with a Layer 1 communication protocol, the method comprising:
receiving, from the first communication network node, a request for information related to measurements performed by the wireless communication device;
receiving from the wireless communication device, measurement results of the performed measurements delivered on the Layer 1 communication protocol; and
forwarding, to the first communication network node, the information according to the received request in accordance with the received request.

43. The method according to claim 41, wherein receiving the request for information comprises receiving a definition that the information will comprise as at least one of: a measurement identity, a measurement type, a measurement value, the complete measurement results, and an indication that the wireless communication device has triggered the measurement.

44. The method according to claim 42, further comprising extracting the information to be forwarded from the received measurement results, by utilizing the received definition.

45. The method according to claim 41, wherein receiving the request for information comprises receiving a User Equipment power Headroom (UPH) Filtering Measurement Forwarding Request Information Element (IE) included in at least one of: a radio link setup request message, a radio link addition request message, a radio link reconfiguration prepare message, and a radio link reconfiguration request message.

46. The method according to claim 42, wherein forwarding the information according to the received request comprises forwarding the requested information formulated as UPH Filtering Value IE of a UE Measurement Forwarding IE included in a radio link parameter update indication message.

47. A second communication network node adapted to be arranged in a communication network for forwarding measurement results from a wireless communication device to a first communication network node in accordance with a Layer 1 communication protocol, the second communication network node comprising:
a communication circuit; and
a controller;
wherein the communication circuit is configured to receive, from the first communication network node, a request for information related to measurements performed by the wireless communication device, and receive, from the wireless communication device, measurement results of the performed measurements in accordance with the Layer 1 communication protocol, wherein the controller is configured to extract the information according to the received request, and wherein the communication circuit is further configured to forward the extracted information to the first communication network node, in accordance with the received request.

48. The second communication network node according to claim 47, wherein the controller is configured to receive the request for information comprising a definition that the information will comprise as at least one of: a measurement identity, a measurement type, a measurement value, the complete measurement result, and an indication that the wireless communication device has triggered the measurement.

49. The second communication network node according to claim 48, wherein the controller is configured to extract the information to be forwarded from the received measurement results, by utilizing the received definition.

50. The second communication network node according to claim 47, wherein the communication circuit is configured to receive the request for information formed as a User Equipment Power Headroom (UPH) Filtering Measurement Forwarding Request Information Element (IE) included in at least one of: a radio link setup request message, a radio link addition request message, a radio link reconfiguration prepare message, and a radio link reconfiguration request message.

51. The second communication network node according to claim 47, wherein communication circuit is configured to forward the requested information formulated as UPH Filtering Value IE of a UE Measurement Forwarding IE included in a radio link parameter update indication message.

52. The second communication network node according to claim 47, wherein the communication circuit is configured to forward the information formulated as a UPH filtering value of Layer 1 signaling.

53. The second communication network node according to claim 47, wherein the second communication network node is an eNodeB.

54. A system for enabling a first communication network node to obtain measurement results from a wireless communication device on a layer 1 communication protocol, the system comprising:
the first communication network node configured to request a second communication network node to forward at least one part of measurement results received from the wireless communication device to the first communication network node; and
the second communication network node configured to receive the measurement results from the wireless communication device and to forward the at least one part of the measurement results to the first communication network node in accordance with the Layer 1 communication protocol.

55. The system according to claim 54, wherein the first communication network node is implemented as an RNC, and the second communication network node is implemented as a NodeB.

56. A non-transitory computer readable medium, having thereon a computer program comprising program instructions, the computer program being loadable into a data-processing unit of a first communication network node of a communication network and configured so that when the program instructions are executed by the data-processing unit, the program instructions cause the first communication network node to:
formulate a request for information related to measurements performed by a wireless communication device;
send the request to a second communication network node; and
receive, from the second communication network node, the requested information in accordance with the Layer 1 communication protocol.
